(19) United States
(12) Patent Application Publication
(10) Pub. No.: US 2011/0146617 A1
(43) Pub. Date: Jun. 23, 2011

(54) AUTOMOTIVE FUEL TANK

(75) Inventors: Junichi Kamio, Saitama (JP); Masahiko Asanuma, Saitama (JP)

(73) Assignee: Honda Motor Co., Ltd., Minato-ku, Tokyo (JP)

(21) Appl. No.: 13/060,007

(22) PCT Filed: Sep. 28, 2009
(86) PCT No.: PCT/JP2009/004945

§ 371 Date: Feb. 21, 2011

(30) Foreign Application Priority Data
Oct. 15, 2008 (JP) 2008-266431

(51) Int. Cl. F02M 25/00; F02B 47/02

(52) U.S. Cl. 123/25 E; 123/25 J

(57) ABSTRACT

To provide a fuel tank capable of easily mixing mixed fuel with water and separating the mixed fuel. The fuel tank comprises a main tank 2, a water tank 3, a separation tank 4, mixed fuel supply unit 6 for supplying the mixed fuel stored in the main tank 2 to the separation tank 4, water supply unit 11 for supplying water stored in the water tank 3 to the separation tank, gasoline supply unit 14 for supplying gasoline to an engine, and alcohol-water supply unit 16 for supplying an alcohol-water mixed liquid to the engine.

### TECHNICAL FIELD

The present invention relates to an automotive fuel tank used for gasoline-alcohol mixed fuel.

### BACKGROUND ART

In recent years, it is known to use a gasoline-alcohol mixed fuel as a fuel for an internal combustion engine. It is considered that, when the mixed fuel is used, the so-called carbon-neutral effect can be obtained by using, as the alcohol of the mixed fuel, ethanol obtained by the fermentation and distillation of a plant substance, for example, a farm crop, such as sugarcane and corn. The carbon-neutral effect means that, when the ethanol originating from the plant substance is used, the total amount of carbon dioxide emitted into the atmosphere in the case of burning the ethanol is theoretically zero. This is because the amount of carbon dioxide emitted into the atmosphere by burning the ethanol obtained from the plant substance is equal to the amount of carbon dioxide absorbed from the atmosphere by the plant itself used as the material to obtain the ethanol.

Therefore, when the mixed fuel of gasoline and ethanol is used as an automotive fuel, it is possible to reduce the emission amount of carbon dioxide and hence to contribute to the prevention of global warming.

As a method for utilizing the mixed fuel, an internal combustion engine system is known which separates the mixed fuel into gasoline and an ethanol-water mixed liquid and supplies the gasoline and the ethanol-water mixed liquid to the engine by mixing the gasoline and the ethanol-water mixed liquid at an arbitrary ratio (see, for example, Patent Literature 1).

Ethanol has a high octane number as compared with gasoline. Thus, when the gasoline and the ethanol-water mixed liquid, which are separated from each other, are mixed at an arbitrary ratio and supplied to the engine, a fuel having an octane number corresponding to the load required by the engine can be supplied to the engine.

As a fuel tank used in the conventional internal combustion engine system, a type is known which further adds water to the main tank storing the gasoline-ethanol mixed fuel, to thereby separate the gasoline-ethanol mixed fuel stored in the main tank into gasoline and an ethanol-water mixed liquid (see, for example, Patent Literature 2).

However, the conventional fuel tank has a disadvantage that, since the gasoline-ethanol mixed fuel is separated into the gasoline and the ethanol-water mixed liquid in the main tank by adding water to the gasoline-ethanol mixed fuel in the main tank, the gasoline-ethanol mixed fuel and water cannot be easily stirred.

### CITATION LIST

### Patent Literature

Patent Literature 1: Japanese Patent Laid-Open No. 2007-255329

Patent Literature 2: Japanese Patent Laid-Open No. 2007-255322

### SUMMARY OF INVENTION

### Technical Problem

An object of the present invention is to eliminate such disadvantage, and to provide an automotive fuel tank capable of easily stirring and mixing the gasoline-alcohol mixed fuel and water to thereby separate gasoline from the alcohol-water mixed liquid.

### Solution to Problem

To this end, an automotive fuel tank according to the present invention is featured by comprising: a main tank for storing a gasoline-alcohol mixed fuel; a water tank for storing water; a separation tank for adding water to the gasoline-alcohol mixed fuel and separating the gasoline-alcohol mixed fuel into gasoline and an alcohol-water mixed liquid; mixed fuel supply unit which supplies gasoline-alcohol mixed fuel stored in the main tank to the separation tank; and water supply unit which supplies water stored in the water tank to the separation tank.

The automotive fuel tank according to the present invention comprises the separation tank separately from the main tank. Therefore, the separation tank can be configured to be smaller than the main tank. Thus, the gasoline-alcohol mixed fuel and water can be supplied in the separation tank so as to be easily stirred and mixed with each other.

When water is mixed with the gasoline-alcohol mixed fuel, since gasoline is hydrophobic and alcohol is hydrophilic, the mixed fuel is separated into two-layers respectively formed of gasoline and alcohol-water mixed liquid. At this time, in the two-layers respectively formed of gasoline and alcohol-water mixed liquid, the gasoline having a smaller specific gravity forms the upper layer, and the alcohol-water mixed liquid having a larger specific gravity forms the lower layer.

Here, the automotive fuel tank according to a first aspect of the present invention is featured by comprising: gasoline supply unit freely floatably provided in the gasoline layer in the separation tank which sucks gasoline and supplies the gasoline to an engine; and alcohol-water supply unit which sucks the alcohol-water mixed liquid in the separation tank and supplies the alcohol-water mixed liquid to the engine.

The fuel tank of the first aspect comprises the gasoline supply unit freely floatably provided in the gasoline layer for sucking gasoline and supplying the gasoline to the engine. With this configuration, the gasoline can be separately taken out. Here, the gasoline supply unit may be floatably provided in the gasoline layer, or may also be floatably provided on the liquid surface of the gasoline layer.

Further, the fuel tank of the first aspect comprises the alcohol-water supply unit for sucking the alcohol-water mixed liquid in the separation tank and supplying the alcohol-water mixed liquid to the engine. With this configuration, the alcohol-water mixed liquid can be separately taken out.

As a result, the gasoline and the alcohol-water mixed liquid can be taken out separately from each other and can be supplied to the engine by being mixed together at an arbitrary ratio.

Further, an automotive fuel tank according to a second aspect of the present invention may also be configured such that the gasoline supply unit which sucks gasoline and supplies the gasoline to the engine is provided in the separation tank instead of being freely floatably provided in the gasoline layer.

Further, it is preferred that the automotive fuel tank according to each of the above described aspects of the present invention comprises: detection unit which detects the alcohol concentration of the gasoline-alcohol mixed fuel stored in the main tank; and control unit which controls the amount of water supplied to the separation tank on the basis of the value of the alcohol concentration detected by the detection unit. The automotive fuel tank according to the present invention can detect the alcohol concentration of the gasoline-alcohol mixed fuel by the detection unit. Therefore, water in an amount necessary to separate gasoline from the gasoline-alcohol mixed fuel can be surely supplied to the separation tank in correspondence with the alcohol concentration of the gasoline-alcohol mixed fuel stored in the main tank.

Further, it is preferred that the automotive fuel tank according to the second aspect of the present invention comprises: interface position detection unit which detects the position of the interface between the gasoline and the alcohol-water mixed liquid in the separation tank; and first gasoline recirculation unit provided at the gasoline supply unit which recirculates the gasoline stored in the separation tank into the main tank at the time when the position of the interface detected by the interface position detection unit becomes lower than a predetermined position.

With this configuration, the interface between the gasoline and the alcohol-water mixed liquid can be grasped, and hence the gasoline can be surely taken out separately by the gasoline supply unit.

Further, when it is detected by the interface position detection unit that the position of the interface between the gasoline and the alcohol-water mixed liquid becomes lower than the predetermined position, the gasoline in the separation tank is recirculated to the main tank by the first gasoline recirculation unit. The mixed fuel and water are further supplied to the free space resultantly formed in the separation tank, so that the gasoline and the alcohol-water mixed liquid can be separated from each other. With this configuration, the ratio of the gasoline and the ethanol-water mixed liquid in the separation tank can be suitably maintained.

Further, it is preferred that the automotive fuel tank according to the second aspect of the present invention comprises: gasoline liquid surface position detection unit which detects the liquid surface position of the gasoline in the separation tank; and second gasoline recirculation unit provided at the gasoline supply unit which recirculates the gasoline to the separation tank at the time when the liquid surface position of gasoline detected by the gasoline liquid surface position detection unit becomes lower than a predetermined position, and that the mixed fuel supply unit is connected to the second gasoline recirculation unit, and mixed fuel suction unit which allows a depressurized portion to be formed due to the flow rate of the gasoline recirculated by the second gasoline recirculation unit and which sucks the mixed fuel stored in the mixed fuel supply unit into the depressurized portion is connected to the connection portion of the second gasoline recirculation unit and the mixed fuel supply unit.

The mixed fuel suction unit is connected to the second gasoline recirculation unit at the connection portion. Thus, when the gasoline recirculated by the second gasoline recirculation unit passes by the mixed fuel suction unit, the depressurized portion is formed in the mixed fuel suction unit due to the flow rate of the gasoline. At this time, since the mixed fuel supply unit is connected to the mixed fuel suction unit, the mixed fuel is sucked from the mixed fuel supply unit into the depressurized portion, and the mixed fuel is supplied to the separation tank together with the gasoline. Therefore, the mixed fuel can be supplied to the separation tank without separately providing an apparatus, such as a pump, for sucking the mixed fuel.

Further, it is preferred that the automotive fuel tank according to the second aspect of the present invention comprises: the gasoline liquid surface position detection unit which detects the liquid surface position of the gasoline in the separation tank; and alcohol-water recirculation unit provided at the alcohol-water supply unit which recirculates the alcohol-water mixed liquid to the separation tank at the time when the liquid surface position of gasoline detected by the gasoline liquid surface position detection unit becomes lower than the predetermined position, and that the water supply unit is connected to the alcohol-water recirculation unit, and water suction unit which allows a depressurized portion to be formed due to the flow rate of the gasoline recirculated by the alcohol-water recirculation unit and which sucks the water stored in the water supply unit into the depressurized portion is provided at the connection portion of the alcohol-water recirculation unit and the water supply unit.

The water suction unit is connected to the alcohol-water recirculation unit at the connection portion. Thus, when the alcohol-water mixed liquid recirculated by the alcohol-water recirculation unit passes by the water suction unit, the depressurized portion is formed in the water suction unit due to the flow rate of the alcohol-water mixed liquid. At this time, since the water supply unit is connected to the water suction unit, the water in the water supply unit is sucked to the depressurized portion, so that the water is supplied to the separation tank together with the alcohol-water mixed liquid. Therefore, the water supply unit can supply the water to the separation tank without being separately provided with an apparatus, such as a pump, for sucking the water.

Further, it is preferred that the automotive fuel tank according to the second aspect of the present invention comprises: the gasoline liquid surface position detection unit which detects the liquid surface position of the gasoline in the separation tank; and the second gasoline recirculation unit provided at the gasoline supply unit which recirculates the gasoline to the separation tank at the time when the liquid surface position of gasoline detected by the gasoline liquid surface position detection unit becomes lower than the predetermined position, and that the mixed fuel supply unit and the water supply unit are connected to the second gasoline recirculation unit, and mixed fuel-water suction unit which allows a depressurized portion to be formed due to the flow rate of the gasoline recirculated by the second gasoline recirculation unit and which sucks the mixed fuel stored in the mixed fuel supply unit and the water stored in the water supply unit into the depressurized portion is provided at the connection portion of the second gasoline recirculation unit with the mixed fuel supply unit and the water supply unit.

The mixed fuel-water suction unit is connected to the second gasoline recirculation unit at the connection portion, and the depressurized portion is formed in the mixed fuel-water suction unit due to the flow rate of the gasoline recirculated by the second gasoline recirculation unit at the time when the gasoline passes by the mixed fuel-water suction unit. At this time, since the mixed fuel supply unit and the water supply unit are connected to the mixed fuel-water suction unit, the mixed fuel in the mixed fuel supply unit and the water in the water supply unit are sucked into the depressurized portion, so that the mixed fuel and the water are supplied to the separation tank together with the gasoline. Therefore, the mixed fuel supply unit and the water supply unit can respectively supply the mixed fuel and the water to the separation tank without being respectively separately provided with an apparatus, such as a pump, for sucking the mixed fuel and the water.

### BRIEF DESCRIPTION OF DRAWINGS

FIG. 1 is an explanatory sectional view showing a configuration of an automotive fuel tank according to a first embodiment.

FIG. 2 is an explanatory sectional view showing a configuration of an automotive fuel tank according to a second embodiment.

FIG. 3 is an explanatory sectional view showing a configuration of an automotive fuel tank according to a third embodiment.

FIG. 4 is an explanatory sectional view showing a configuration of an automotive fuel tank according to a fourth embodiment.

### DESCRIPTION OF EMBODIMENTS

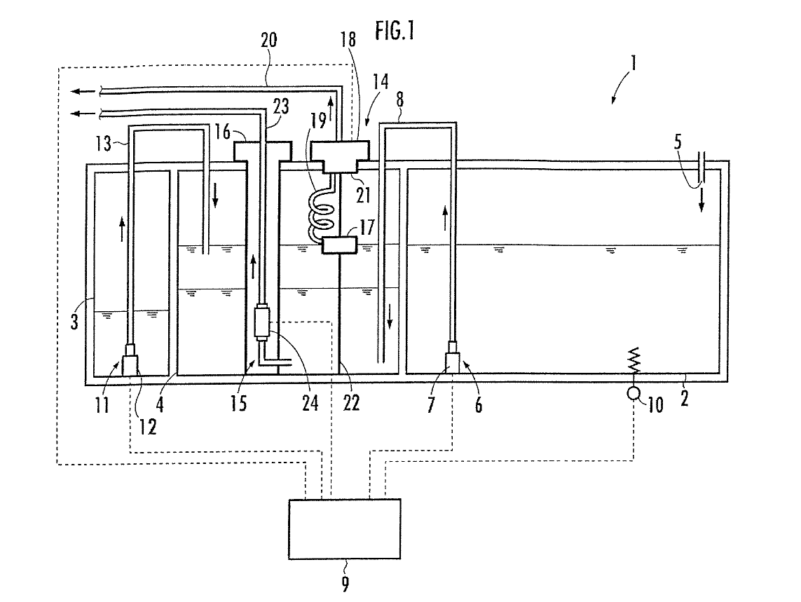

A fuel tank 1 according to a first embodiment of the present invention is configured by a main tank 2, a water tank 3, and a separation tank 4 as shown in FIG. 1. The main tank 2 is configured to store gasoline-ethanol mixed fuel as gasoline-alcohol mixed fuel. The water tank 3 is configured to store water. The separation tank 4 is configured to add water to the gasoline-ethanol mixed fuel to separate the gasoline-ethanol mixed fuel and the water into gasoline and an ethanol-water mixed liquid. Each of the tanks 2, 3 and 4 is provided adjacent to each other. As for the capacity of each of the tanks, for example, the capacity of the main tank 2 is 50 liters, the capacity of the water tank 3 is 3 liters, and the capacity of the separation tank 4 is 2 liters.

The main tank 2 comprises a mixed fuel supply port 5 provided at an upper portion thereof, and a mixed fuel pump unit 6. The mixed fuel pump unit 6 is configured by a mixed fuel pump 7 and a first conduit 8. The mixed fuel pump 7 is provided at a bottom portion of the main tank 2, and is a low pressure pump for use in the liquid pressure range of at most 0.1 MPa. One end of the first conduit 8 is connected to the mixed fuel pump 7, and the other end of the conduit 8 is opened in a lower portion of the separation tank 4. The mixed fuel pump 7 is electrically connected to a control apparatus 9, and the drive of the mixed fuel pump 7 is controlled by the control apparatus 9.

Further, ethanol concentration detection unit 10 is provided at a bottom portion of the main tank 2. The ethanol concentration detection unit 10 is electrically connected to the control apparatus 9.

The water tank 3 comprises a water pump unit 11. The water pump unit 11 is configured by a water pump 12 and a second conduit 13. The water pump 12 is provided at a bottom portion of the water tank 3 and is a low pressure pump for use in the liquid pressure range of at most 0.1 MPa. One end of the second conduit 13 is connected to the water pump 12, and the other end of the second conduit 13 is opened in an upper portion of the separation tank 4. The water pump 12 is electrically connected to the control apparatus 9, and the drive of the water pump 12 is controlled by the control apparatus 9.

The separation tank 4 stores the gasoline and the ethanol-water mixed liquid, each of which is separated from the mixed fuel. In the separation tank 4, the gasoline forms the upper layer, and the ethanol-water mixed liquid forms the lower layer.

The separation tank 4 comprises a gasoline pump unit 14 and an ethanol-water pump unit 15. Further, a cylindrical member 16 is inserted into the separation tank 4 from an upper portion of the separation tank 4.

The gasoline pump unit 14 comprises a float 17, a gasoline pump 18, a first gasoline supply pipe 19, and a second gasoline supply pipe 20. The float 17 is configured to float on the liquid surface of the gasoline layer. The gasoline pump 18 is provided on the upper surface of the main tank 2. The first gasoline supply pipe 19 is an extensible and contractible pipe, one end of which is connected to the float 17, and the other end of which is connected to the gasoline pump 18. One end of the second gasoline supply pipe 20 is connected to the gasoline pump 18, and the other end of the gasoline supply pipe 20 is connected to an engine (not shown). The gasoline pump 18, which is a high pressure pump for use in the liquid pressure range of 0.2 to 0.7 MPa, is electrically connected to the control apparatus 9, and the drive of the gasoline pump 18 is controlled by the control apparatus 9. The float 17 is configured to freely move in the vertical direction along a guide member 22 suspended vertically downward from float position detection unit 21 provided at an upper portion of the separation tank 4. The float position detection unit 21 detects the liquid surface of the gasoline layer by detecting the position of the float 17 which floats according to the vertical movement of the liquid surface of the gasoline layer. The float position detection unit 21 is electrically connected to the control apparatus 9 and transmits the position information of the float 17 to the control apparatus 9.

The ethanol-water pump unit 15 is configured by an ethanol-water supply pipe 23 and an ethanol-water pump 24. One end of the ethanol-water supply pipe 23 is opened in the ethanol-water layer formed in the lower portion of the separation tank 4, and the other end of the ethanol-water supply pipe 23 is connected to the engine. The ethanol-water pump 24 is provided in the middle of the ethanol-water supply pipe 23. The ethanol-water pump 24, which is a high pressure pump for use in the liquid pressure range of 0.2 to 0.7 MPa, is electrically connected to the control apparatus 9, and the drive of the ethanol-water pump 24 is controlled by the control apparatus 9.

Next, the operation in the automotive fuel tank 1 of the first embodiment will be described.

First, the ethanol concentration of the gasoline-ethanol mixed fuel stored in the main tank 2 is detected by the ethanol concentration detection unit 10. Next, according to the value of the detected ethanol concentration, the mixing ratio of the gasoline-ethanol mixed fuel and water is determined by the control apparatus 9.

Next, the mixed fuel pump 7 and the water pump 12 are driven by the control apparatus 9, so that a predetermined amount of the gasoline-ethanol mixed fuel and a predetermined amount of water are supplied to the separation tank 4 respectively via the first conduit 8 and the second conduit 13 so as to allow the mixing ratio of the gasoline-ethanol mixed fuel and the water to become the determined mixing ratio. At this time, the mixed fuel is supplied to the lower portion of the separation tank 4, and the water is supplied to the upper portion of the separation tank 4. The mixed fuel has a smaller specific gravity, and the water has a larger specific gravity. Therefore, the mixed fuel and the water, which are supplied as described above, are circulated in the separation tank 4 due to the difference between their specific gravities, so as to be stirred and mixed together.

In the automotive fuel tank 1 of the first embodiment, the separation tank 4 can be reduced to the capacity of 2 liters as compared with the main tank 2 having the capacity of 50 liters. Therefore, the mixed fuel and the water can be easily stirred and mixed together in the separation tank 4.

Since in the mixed fuel composed of ethanol and gasoline, the ethanol is hydrophilic and the gasoline is hydrophobic. Thus, when water is mixed with the mixed fuel, the mixed fuel is separated to two upper and lower layers respectively formed of gasoline and ethanol-water mixed liquid. At this time, the gasoline, which has a smaller specific gravity, forms the upper layer, and the ethanol-water mixed liquid, which has a larger specific gravity, forms the lower layer.

When the separation of the mixed fuel proceeds in this way, the amounts of the gasoline and of the ethanol-water mixed liquid in the separation tank 4 are increased, so that the position of the float 17 is raised. When the reaching of the float 17 to the uppermost portion is detected by the float position detection unit 21, it is determined by the control apparatus 9 that the inside of the separation tank 4 is filled with the gasoline and the ethanol-water mixed liquid. Then, the mixed fuel pump 7 and the water pump 12 are stopped by the control unit 9.

Further, in the automotive fuel tank 1 of the first embodiment, when the gasoline pump 18 is driven by the control apparatus 9, the gasoline in the separation tank 4 is sucked from the end portion of the first gasoline supply pipe 19 on the side of the float 17. The sucked gasoline is supplied to the engine via the second gasoline supply pipe 20. Further, when the ethanol-water pump 24 is driven by the control apparatus 9, the ethanol-water mixed liquid in the separation tank 4 is sucked into the ethanol-water supply pipe 23. The sucked ethanol-water mixed liquid is supplied to the engine via the ethanol-water supply pipe 23.

Therefore, with the automotive fuel tank 1 of the first embodiment, each of the gasoline and the ethanol-water mixed liquid can be independently taken out. As a result, the automotive fuel tank 1 of the first embodiment can supply the gasoline and the ethanol-water mixed liquid to the engine by mixing the gasoline with the ethanol-water mixed liquid at an arbitrary ratio.

When the gasoline and the ethanol-water mixed liquid are supplied to the engine respectively by the gasoline pump 18 and the ethanol-water pump 24, the amounts of the gasoline and the ethanol-water mixed liquid in the separation tank 4 are reduced, so that the position of the float 17 is lowered. When it is detected by the float position detection unit 21 that the position of float 17 is lower than a predetermined position, the mixed fuel pump 7 and the water pump 12 are driven by the control apparatus 9, and the supply of the mixed fuel and the water is resumed as described above.

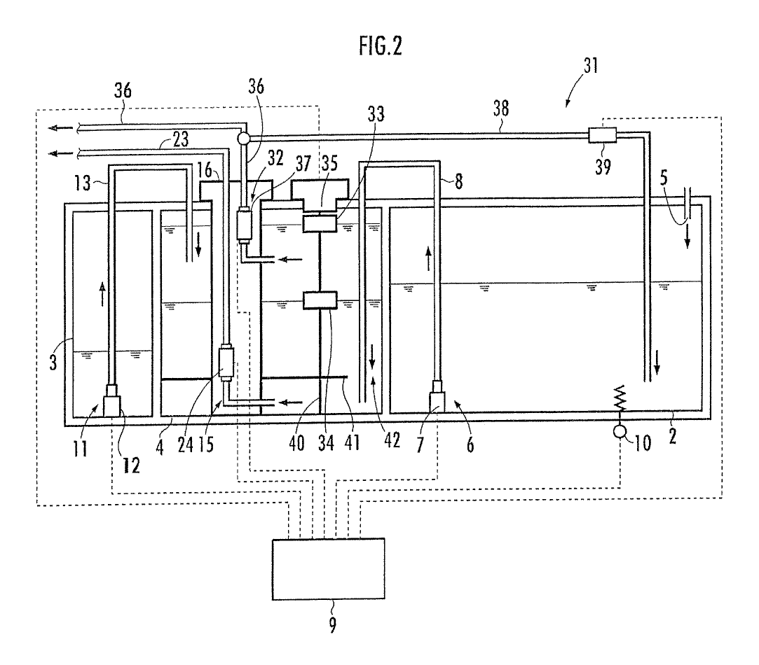

Next, as shown in FIG. 2, a fuel tank 31 according to a second embodiment of the present invention comprises a gasoline pump unit 32 in place of the gasoline pump unit 14 of the automotive fuel tank 1 of the first embodiment. Further, the fuel tank 31 according to the second embodiment of the present invention comprises a first float sensor 33, a second float sensor 34, and float position detection unit 35 in place of the float 17 and the float position detection unit 21 of the automotive fuel tank 1 of the first embodiment. The other configuration of the fuel tank 31 according to the second embodiment of the present invention is completely the same as the configuration of the fuel tank 1 of the first embodiment.

The gasoline pump unit 32 is configured by a gasoline supply pipe 36 and a gasoline pump 37. One end of the gasoline supply pipe 36 is opened in the gasoline layer in the upper portion of the separation tank 4, and the other end of the gasoline supply pipe 36 is connected to the engine (not shown). The gasoline pump 37 is provided in the middle of the gasoline supply pipe 36 and in the upper portion in the cylindrical member 16. The gasoline pump 37, which is a high pressure pump for use in the liquid pressure range of 0.2 to 0.7 MPa, is electrically connected to the control apparatus 9, and the drive of the gasoline pump 37 is controlled by the control apparatus 9.

Further, the gasoline supply pipe 36 further comprises a gasoline recirculation pipe 38. The gasoline recirculation pipe 38 is branched from the gasoline supply pipe 36 on the downstream side from the gasoline pump 37. The gasoline recirculation pipe 38, the downstream end of which is opened in the main tank 2, comprises a recirculation control valve 39 in the middle of the gasoline recirculation pipe 38. The recirculation control valve 39 is electrically connected to the control apparatus 9, and the opening and closing of the recirculation control valve 39 are controlled by the control apparatus 9.

The float sensor 33 is configured so as to float on the liquid surface of the gasoline layer. The float sensor 34 is configured so as to float at the interface between the gasoline and the ethanol-water mixed liquid. The float sensors 33 and 34 are configured so as to be freely movable in the vertical direction along a guide member 40 vertically suspended downward from the float position detection unit 35 provided in an upper portion of the separation tank 4.

The float sensor 33 floats according to the vertical movement of the liquid surface of the gasoline layer, so as to detect the liquid surface of the gasoline layer. The float sensor 34 floats according to the vertical movement of the interface between the gasoline and the ethanol-water mixed liquid, so as to detect the interface. The float position detection unit 35 is electrically connected to the control apparatus 9, so as to transmit the position information of the float sensors 33 and 34 to the control apparatus 9.

Also, the separation tank 4 further comprises a partition plate 41. The partition plate 41 is provided so as to horizontally extend in the portion immediately above the opening portion of the first conduit 8. Further, the partition plate 41 comprises a fuel flow section 42 on one edge side of the separation tank 4. The fuel, such as the ethanol-water mixed liquid, can be made to flow into portions above and below the partition plate 41 via the fuel flow section 42.

Next, the operation in the automotive fuel tank 31 of the second embodiment will be described.

First, similarly to the case of the automotive fuel tank 1 of the first embodiment, the mixed fuel pump 7 and the water pump 12 are driven by the control apparatus 9, so that a predetermined amount of the ethanol mixed fuel and a predetermined amount of the water are supplied to the separation tank 4 respectively via the first conduit 8 and the second conduit 13. Then, when the mixed fuel and the water, which are supplied in this way, are stirred and mixed together in the separation tank 4, the mixed fuel is separated into the two upper and lower layers respectively formed of the gasoline and the ethanol-water mixed liquid.

When the separation of the mixed fuel proceeds, the amounts of the gasoline and of the ethanol-water mixed liquid in the separation tank 4 are increased, so that the position of the float sensor 33 is raised. When the reaching of the float sensor 33 to the uppermost portion is detected by the float position detection unit 35, it is determined by the control apparatus 9 that the inside of the separation tank 4 is filled with the gasoline and the ethanol-water mixed liquid. Then, the mixed fuel pump 7 and the water pump 12 are stopped by the control unit 9.

Further, with the automotive fuel tank 31 of the second embodiment, the position of the liquid surface of the gasoline layer and the position of the interface between the gasoline and the ethanol-water mixed liquid can be grasped by the float sensors 33 and 34 and the float position detection unit 35. When the position of the float sensor 33 is sufficiently higher than the opening portion of the gasoline supply pipe 36, and when the position of the float sensor 34 is sufficiently lower than the opening portion of the gasoline supply pipe 36, it is determined by the control apparatus 9 that the gasoline in the separation tank 4 can be supplied to the engine. Then, the gasoline pump 37 is driven by the control apparatus 9, and thereby the gasoline is sucked by the gasoline supply pipe 36. The sucked gasoline is supplied to the engine via the gasoline supply pipe 36.

When the position of the float sensor 34 is higher than the position of the partition plate 41, it is determined by the control apparatus 9 that the ethanol-water mixed liquid in the separation tank 4 can be supplied to the engine. Then, the ethanol-water pump 24 is driven by the control apparatus 9, and thereby the ethanol-water mixed liquid is sucked by the ethanol-water supply pipe 23. The sucked ethanol-water mixed liquid is supplied to the engine via the ethanol-water supply pipe 23.

Therefore, with the automotive fuel tank 31 of the second embodiment, each of the gasoline and the ethanol-water mixed liquid can be independently taken out. As a result, the automotive fuel tank 31 of the second embodiment can supply the gasoline and the ethanol-water mixed liquid to the engine by mixing the gasoline with the ethanol-water mixed liquid at an arbitrary ratio.

When the gasoline and the ethanol-water mixed liquid are supplied to the engine respectively by the gasoline pump 37 and the ethanol-water pump 24, the amounts of the gasoline and of the ethanol-water mixed liquid in the separation tank 4 are reduced, so that the position of the float sensor 33 is lowered. When it is detected by the float position detection unit 35 that the position of the float sensor 33 is lower than a predetermined position, the mixed fuel pump 7 and the water pump 12 are driven by the control apparatus 9, so that the supply of the mixed fuel and the water is resumed as described above.

When the separation of the mixed fuel is intermittently performed in this way, the relative ratio of the gasoline in the separation tank 4 may be increased so as to cause the position of the float sensor 34 to become lower than a predetermined position. When such state is detected by the float position detection unit 35, the control apparatus 9 opens the recirculation control valve 39 provided in the gasoline recirculation pipe 38, so as to recirculate the gasoline into the main tank 2. With this operation, the ratio of the gasoline and the ethanol-water mixed liquid in the separation tank 4 can be suitably maintained by the fuel tank 31.

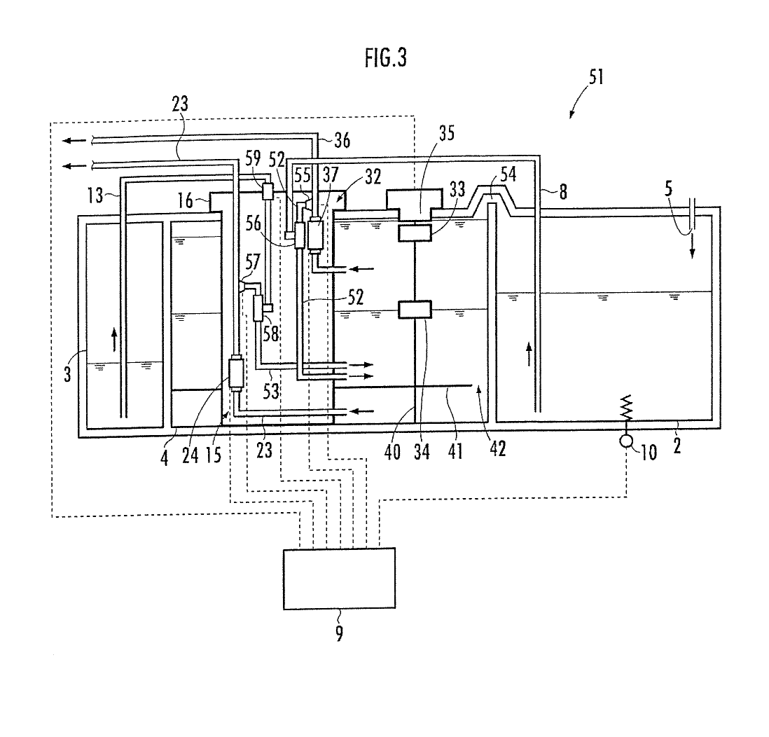

Next, an automotive fuel tank 51 according to a third embodiment of the present invention comprises, as shown in FIG. 3, a first recirculation pipe 52 branched from the gasoline supply pipe 36 in place of the mixed fuel pump unit 6 of the automotive fuel tank 31 of the second embodiment. Further, the automotive fuel tank 51 according to the third embodiment of the present invention comprises a second recirculation pipe 53 branched from the ethanol-water supply pipe 23 in place of the water pump unit 11 of the automotive fuel tank 31 of the second embodiment. Further, the automotive fuel tank 51 according to the third embodiment of the present invention comprises a communication pipe 54 for communicating the uppermost portion of the main tank 2 and the separation tank 4 in place of the gasoline recirculation pipe 38 of the automotive fuel tank 31 of the second embodiment. The other configuration of the automotive fuel tank 51 according to the third embodiment of the present invention is completely the same as the configuration of the automotive fuel tank 1 of the second embodiment.

The first recirculation pipe 52 is connected to the gasoline supply pipe 36 on the downstream side of the gasoline pump 37 via a first control valve 55. The downstream end portion of the first recirculation pipe 52 is opened at a position immediately above the partition plate 41 in the separation tank 4. The first control valve 55 is electrically connected to the control apparatus 9, so that the opening and closing of the first control valve 55 is controlled by the control apparatus 9.

Further, the first recirculation pipe 52 comprises a first ejector 56 in the middle of the first recirculation pipe 52. The first conduit 8 is connected to the first ejector 56. The first conduit 8, the upstream end portion of which is opened in the lower portion of the main tank 2, does not comprise the mixed fuel pump 7.

Further, the second recirculation pipe 53 is connected to the ethanol-water supply pipe 23 on the downstream side of the ethanol-water pump 24 via a second control valve 57. The downstream end portion of the second recirculation pipe 53 is opened at a position immediately above the partition plate 41 in the separation tank 4 and in the vicinity of the first recirculation pipe 52. The second control valve 57 is connected to the control apparatus 9, so that the opening and closing of the second control valve 57 are controlled by the control apparatus 9.

Further, the second recirculation pipe 53 comprises a second ejector 58 in the middle of the second recirculation pipe 53. The second conduit 13 is connected to the second ejector 58. The second conduit 13, the upstream end portion of which is opened in the bottom portion of the water tank 3, does not comprise the water pump 12. Further, the second conduit 13 comprises an opening and closing valve 59 in the middle thereof. The opening and closing valve 59 is electrically connected to the control apparatus 9, so that the opening and closing of the opening and closing valve 59 are controlled by the control apparatus 9.

Next, the operation in the automotive fuel tank 51 of the third embodiment will be described.

In the initial state, the gasoline is stored in the upper layer of the separation tank 4 of the automotive fuel tank 51, and the ethanol-water mixed liquid is stored in the lower layer of the separation tank 4. At this time, the float sensor 33 is located above the opening portion of the gasoline supply pipe 36 in the separation tank 4, and the float sensor 34 is located above the opening portion of the ethanol-water supply pipe 23 in the separation tank 4.

In this state, the gasoline pump 37 and the ethanol-water pump 24 are driven by the control apparatus 9, so that the gasoline and the ethanol-water mixed liquid are supplied to the engine at a predetermined ratio. When the gasoline and the ethanol-water mixed liquid are supplied to the engine and consumed, the positions of the float sensors 33 and 34 are lowered. When the first float sensor 33 reaches a predetermined position above the opening portion of the gasoline supply pipe 36, it is determined by the control apparatus 9 that it is necessary to increase the amount of the gasoline in the separation tank 4. Then, the control valves 55 and 57 and the opening and closing valve 59 are opened by the control apparatus 9 in order to start separation of the mixed fuel.

When the first control valve 55 is opened, a part of the gasoline supplied in the gasoline supply pipe 36 is made to flow into the first recirculation pipe 52, so as to be recirculated to the separation tank 4. At this time, the gasoline is supplied to the first ejector 56, so that a depressurized portion is formed in the first ejector 56 due to the flow rate of the gasoline. As a result, the mixed fuel is sucked to the depressurized portion from the first conduit 8 connected to the first ejector 56. Then, the mixed fuel is supplied in the separation tank 4 via the first recirculation pipe 52 together with the gasoline.

Further, when the second control valve 57 and the opening and closing valve 59 are opened, a part of the ethanol-water mixed liquid supplied in the ethanol-water supply pipe 23 is made to flow into the second recirculation pipe 53, so as to be recirculated to the separation tank 4. At this time, the ethanol-water mixed liquid is supplied to the second ejector 58, so that a depressurized portion is formed in the second ejector 58 due to the flow rate of the ethanol-water mixed liquid. As a result, the water is sucked to the depressurized portion from the second conduit 13 connected to the second ejector 58. Then, the water is supplied in the separation tank 4 via the second recirculation pipe 53 together with the ethanol-water mixed liquid.

At this time, the ethanol concentration of the gasoline-ethanol mixed fuel stored in the main tank 2 is detected by the ethanol concentration detection unit 10. Thus, according to the detected ethanol concentration, the opening degree of the opening and closing valve 59 is controlled by the control apparatus 9 so that the amounts of the mixed fuel and of the water are set to a suitable ratio.

The mixed fuel and the water are supplied in the separation tank 4 by the recirculation pipes 52 and 55. At this time, the opening sections of the recirculation pipes 52 and 55 are provided adjacent to each other in the separation tank 4. Therefore, the mixed fuel and the water, which are supplied in the separation tank 4, are efficiently mixed with each other, so as to be separated into the gasoline and the ethanol-water mixed liquid.

When the mixed fuel is separated in this way, the amounts of the gasoline and of the ethanol-water mixed liquid in the separation tank 4 are increased, so that the positions of the float sensors 33 and 34 are raised. Then, when the position of the float sensor 34 reaches a predetermined position below the opening portion of the gasoline supply pipe 36, the control valves 55 and 57, and the opening and closing valve 59 are closed by the control apparatus 9, so that the separation of the mixed fuel is stopped. As a result, the separation tank 4 is made to return to the initial state.

Meanwhile, the first float sensor 37 may reach the uppermost portion before the float sensor 34 reaches the predetermined position below the opening portion of the gasoline supply pipe 36. In such case, the portion of the gasoline, which exceeds the permissible amount of the separation tank 4, is recirculated to the main tank 2 via the communication pipe 54. The separation of the mixed fuel is continued until the float sensor 34 reaches the predetermined position.

Next, when the separation of the mixed fuel is stopped, the gasoline and the ethanol-water mixed liquid are again supplied to the engine, so as to be consumed. As a result, when the position of the float sensor 33 is lowered to reach the predetermined position above the opening portion of the gasoline supply pipe 36, the control valves 55 and 57, and the opening and closing valve 59 are opened by the control apparatus 9, so that the supply of the mixed fuel and the water is resumed.

Further, in the automotive fuel tank 51 of the third embodiment, the first ejector 56 and the second ejector 58 are provided to thereby make it possible to eliminate the need for a pump to be exclusively used for supplying each of the mixed fuel and the water to the separation tank 4.

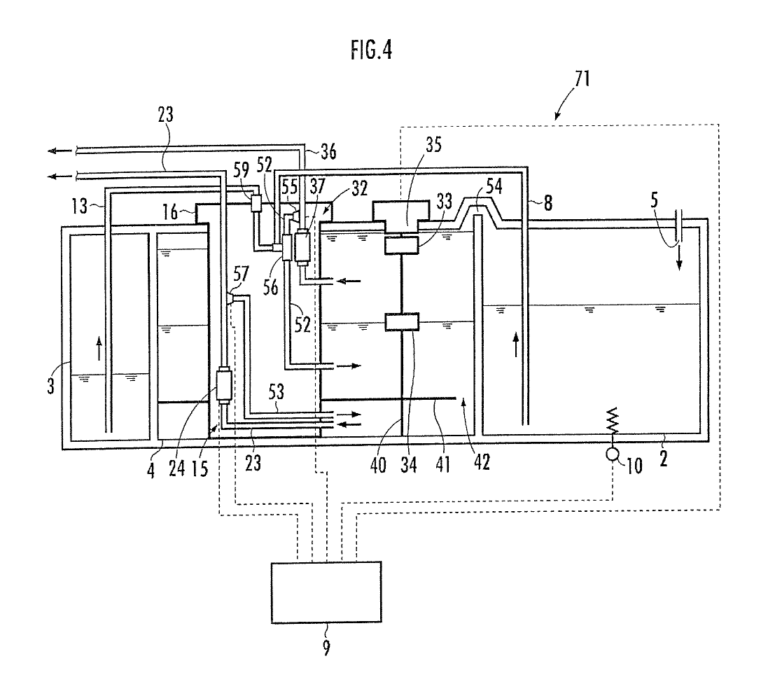

Next, an automotive fuel tank 71 according to a fourth embodiment of the present invention is configured such that, as shown in FIG. 4, the second conduit 13 is connected to the first ejector 56 instead of that the second conduit 13 in the automotive fuel tank 51 of the third embodiment is connected to the second ejector 58. Further, the automotive fuel tank 71 of the fourth embodiment does not comprise the second ejector 58 in the automotive fuel tank 51 of the third embodiment. Further, in the automotive fuel tank 71 of the fourth embodiment, the second recirculation pipe 53 in the automotive fuel tank 51 of the third embodiment is opened at a position below the partition plate 41 in the separation tank 4. The other configuration of the automotive fuel tank 71 according to the fourth embodiment of the present invention is completely the same as the configuration of the automotive fuel tank 51 of the third embodiment.

Next, the operation in the automotive fuel tank 71 of the fourth embodiment will be described.

In the initial state, the gasoline is stored in the upper layer of the separation tank 4 of the automotive fuel tank 71, and the ethanol-water mixed liquid is stored in the lower layer of the separation tank 4. At this time, the float sensor 33 is located at a position above the opening portion of the gasoline supply pipe 36 in the separation tank 4, and the float sensor 34 is located at a position above the opening portion of the ethanol-water supply pipe 23 in the separation tank 4.

In this state, completely similarly to the automotive fuel tank 51 of the third embodiment, the gasoline and the ethanol-water mixed liquid are supplied to the engine at a predetermined ratio. When the gasoline and the ethanol-water mixed liquid are supplied to the engine and consumed, the positions of float sensors 33 and 34 are lowered. When the first float sensor 33 reaches the predetermined position above the opening portion of the gasoline supply pipe 36, it is determined by the control apparatus 9 that it is necessary to increase the amount of the gasoline in the separation tank 4. Then, the control valves 55 and 57, and the opening and closing valve 59 are opened by control apparatus 9 in order to start the separation of the mixed fuel.

When the first control valve 55, and the opening and closing valve 59 are opened, a part of the gasoline supplied in the gasoline supply pipe 36 is made to flow into the first recirculation pipe 52, so as to be recirculated to the separation tank 4. At this time, the gasoline is supplied to the first ejector 56, so that a depressurized portion is formed in the first ejector 56 due to the flow rate of the gasoline. As a result, the mixed fuel is sucked from the first conduit 8 connected to the first ejector 56, and the water is sucked from the second conduit 13 connected to the first ejector 56. Thereby, the mixed fuel and the water are supplied to the separation tank 4 together with the gasoline via the first recirculation pipe 52. The other operations in the automotive fuel tank 71 according to the fourth embodiment of the present invention are completely the same as the operations in the automotive fuel tank 51 of the third embodiment.

In the automotive fuel tank 71 of the fourth embodiment, the second ejector 58 can be eliminated by connecting the conduits 8 and 13 to the first ejector 56, so that the number of ejectors can be reduced.

Note that in the automotive fuel tank 71 of the fourth embodiment, the conduits 8 and 13 are connected to the first ejector 56 in order to reduce the number of ejectors. However, the configuration to reduce the number of ejectors is not limited to this, and the conduits 8 and 13 may also be connected to the second ejector 58 in the fuel tank 51.

Note that in the automotive fuel tanks 1, 31, 51 and 71 of the respective embodiments, the separation tank 4 may comprise, for example, unit for sufficiently mixing the mixed fuel with the water in the separation tank 4 by using an aspirator or a stirrer. Alternatively, the separation tank 4 may also comprise unit for stirring the mixed fuel and the water by ejecting the mixed fuel or the water to be supplied to the separation tank 4 circumferentially from above the separation tank 4.

Further, in the automotive fuel tanks 1, 31, 51 and 71 of the respective embodiments, in order to prevent the freezing of the water stored in the water tank 3, the water tank 3 may comprise a heater, and the like, and may also comprise unit for supplying a part of the separated ethanol-water mixed liquid into the water tank 3.

Further, in the automotive fuel tanks 1, 31, 51 and 71 of the respective embodiments, water separated from the engine exhaust gas may be used as the water stored in the water tank 3, and water separated from the window washer liquid may also be used as the water stored in the water tank 3.

### REFERENCE SIGNS LIST

1, 31, 51, 71 Fuel tank

2 Main tank

3 Water tank

4 Separation tank

6 Mixed fuel pump unit (mixed fuel supply unit)

9 Control apparatus

10 Ethanol concentration detection unit (alcohol concentration detection unit)

11 Water pump unit (water supply unit)

14, 32 Gasoline pump unit (gasoline supply unit)

15 Ethanol-water pump unit (alcohol-water supply unit)

21, 35 Float position detection unit (interface position detection unit)

38 Gasoline recirculation pipe (first gasoline recirculation unit)

52 First recirculation pipe (second gasoline recirculation unit)

53 Second recirculation pipe (alcohol-water recirculation unit)

56 First ejector (mixed fuel suction unit, mixed fuel-water suction unit)

58 Second ejector (water suction unit).

1. An automotive fuel tank including a main tank for storing gasoline-alcohol mixed fuel, a water tank for storing water, a separation tank for adding water to the gasoline-alcohol mixed fuel and separating the gasoline-alcohol mixed fuel into gasoline and an alcohol-water mixed liquid, a mixed fuel supply unit which supplies the gasoline-alcohol mixed fuel stored in the main tank to the separation tank, and a water supply unit which supplies the water stored in the water tank to the separation tank, the automotive fuel tank comprising:
a gasoline supply unit freely floatably provided in the gasoline layer in the separation tank which sucks gasoline and supplies the gasoline to an engine; and
an alcohol-water supply unit which sucks the alcohol-water mixed liquid in the separation tank and supplies the alcohol-water mixed liquid to the engine.

2. The automotive fuel tank according to claim 1, further comprising:
an alcohol concentration detection unit which detects the alcohol concentration of the gasoline-alcohol mixed fuel stored in the main tank; and
a supply water amount control unit which controls the amount of water supplied to the separation tank on the basis of the value of the alcohol concentration detected by the alcohol concentration detection unit.

3. An automotive fuel tank including a main tank for storing gasoline-alcohol mixed fuel, a water tank for storing water, a separation tank for adding water to the gasoline-alcohol mixed fuel and separating the gasoline-alcohol mixed fuel into gasoline and an alcohol-water mixed liquid, a mixed fuel supply unit which supplies the gasoline-alcohol mixed fuel stored in the main tank to the separation tank, and a water supply unit which supplies the water stored in the water tank to the separation tank, the automotive fuel tank comprising:
a gasoline supply unit provided in the separation tank which sucks the gasoline and supplies the gasoline to an engine; and
an alcohol-water supply unit which sucks the alcohol-water mixed liquid in the separation tank and supplies the alcohol-water mixed liquid to the engine.

4. The automotive fuel tank according to claim 3, further comprising:
an alcohol concentration detection unit which detects the alcohol concentration of the gasoline-alcohol mixed fuel stored in the main tank; and
a supply water amount control unit which controls the amount of water supplied to the separation tank on the basis of the value of the alcohol concentration detected by the alcohol concentration detection unit.

5. The automotive fuel tank according to claim 3, further comprising:
an interface position detection unit which detects the position of the interface between the gasoline and the alcohol-water mixed liquid in the separation tank; and
a first gasoline recirculation unit provided at the gasoline supply unit which recirculates the gasoline stored in the separation tank into the main tank at the time when the position of the interface detected by the interface position detection unit becomes lower than a predetermined position.

6. The automotive fuel tank according to claim 3, further comprising:
a gasoline liquid surface position detection unit which detects the position of the liquid surface of the gasoline in the separation tank; and
a second gasoline recirculation unit provided at the gasoline supply unit which recirculates the gasoline to the separation tank at the time when the position of the gasoline liquid surface detected by the gasoline liquid surface position detection unit becomes lower than a predetermined level,
wherein the mixed fuel supply unit is connected to the second gasoline recirculation unit, and
wherein a mixed fuel suction unit which allows a depressurized portion to be formed due to the flow rate of the gasoline recirculated by the second gasoline recirculation unit and which sucks the mixed fuel stored in the mixed fuel supply unit into the depressurized portion is connected to the connection portion of the second gasoline recirculation unit and the mixed fuel supply unit.

7. The automotive fuel tank according to claim 3, further comprising:
a gasoline liquid surface position detection unit for detecting the position of the liquid surface of the gasoline in the separation tank; and
an alcohol-water recirculation unit provided at the alcohol-water supply unit which recirculates the alcohol-water mixed liquid to the separation tank at the time when the position of the gasoline liquid surface detected by the gasoline liquid surface position detection unit becomes lower than a predetermined level,
wherein the water supply unit is connected to the alcohol-water recirculation unit, and
wherein a water suction unit which allows a depressurized portion to be formed due to the flow rate of the alcohol-water mixed liquid recirculated by the alcohol-water recirculation unit and which sucks the water stored in the water supply unit into the depressurized portion is provided at the connection portion of the alcohol-water recirculation unit and the water supply unit.

8. The automotive fuel tank according to claim 3, further comprising:
a gasoline liquid surface position detection unit which detects the position of the liquid surface of the gasoline in the separation tank; and
a second gasoline recirculation unit provided at the gasoline supply unit which recirculates the gasoline to the separation tank at the time when the position of the gasoline liquid surface detected by the gasoline liquid surface position detection unit becomes lower than a predetermined level,
wherein the mixed fuel supply unit and the water supply unit are connected to the gasoline recirculation unit, and a mixed fuel-water suction unit which allows a depressurized portion to be formed due to the flow rate of the gasoline recirculated by the second gasoline recirculation unit and which sucks the mixed fuel stored in the mixed fuel supply unit and the water stored in the water supply unit into the depressurized portion is provided at the connection portion of the second gasoline recirculation unit with the mixed fuel supply unit and the water supply unit.

9. The automotive fuel tank according to claim 3, wherein the separation tank comprises, at the uppermost portion thereof, a communication pipe communicating with the main tank for recirculating the gasoline to the main tank at the time when the gasoline stored in the separation tank exceeds a permissible amount of the gasoline.
